(19) United States
(12) Patent Application Publication
(10) Pub. No.: US 2003/0235177 A1
(43) Pub. Date: Dec. 25, 2003

(54) Composite access point apparatus, and method for processing voice/data packets using the same

(76) Inventor: Yeon-Chun Park, Seoul (KR)

Correspondence Address: Robert E. Bushnell, Suite 300, 1522 K Street, N.W., Washington, DC, 20005-1202, US

(21) Appl. No.: 10/419,073

(22) Filed: Apr. 21, 2003

(30) Foreign Application Priority Data
Jun. 19, 2002 (KR) 2002-34326

(51) Int. Cl. H04Q 7/24

(52) U.S. Cl. 370/338

(57) ABSTRACT

Disclosed is a composite access point apparatus which can process voice packets and data packets at the same time in a wireless data communication system using a wireless local area network, and a method for processing voice packets and data packets using the same. The composite access point apparatus confirms a kind of inputted packets, transmits the data packets to a data network, and decodes the voice packets and transmits them to a connected private branch exchange or key telephone system.

### CLAIM OF PRIORITY

This application makes reference to, incorporates the same herein, and claims all benefits accruing under 35 U.S.C. §119 from my application COMPOUND ACCESS POINT AND METHOD FOR MANAGING VOICE/DA TA PACKET USING THE ACCESS POINT filed with the Korean Industrial Property Office on Jun. 19, 2002 and there duly assigned Serial No. 34326/2002.

### BACKGROUND OF THE INVENTION

1. Technical Field

The present invention relates generally to a wireless data communication system and, in particular, to an apparatus which can process voice packets and data packets at the same time in a wireless data communication system, and a method for processing voice packets and data packets using the apparatus.

2. Related Art

A the wireless data communication system using a wireless local area network (WLAN) includes wireless data communication terminals, an access point, a local area network (LAN), the Internet, a public switched telecommunications network (PSTN), a private branch exchange (PBX), a voice over Internet protocol (VoIP) gateway, and a wireless local area network (WLAN).

A transmission path of voice packets and data packets in the wireless data communication system will now be explained. Here, the data packets imply data packets which need not to be transmitted in a real time like the voice packets. The wireless data communication terminals such as a wireless voice over Internet protocol (VoIP) terminal, a personal digital assistant (PDA) and a personal computer on which a wireless local area network (WLAN) card is mounted transmit voice or data to the wireless local area network (WLAN) in form of packets. The wireless data communication terminals convert a voice signal inputted by a user into a pulse code modulation (PCM) voice data, and convert the pulse code modulation (PCM) voice data into a signal frame suitable for the wireless local area network (WLAN) communication standards by compression, thereby transmitting the voice data in form of packets like general data.

The access point receiving the voice packets and data packets from the wireless data communication terminals outputs the received packets to the local area network (LAN) which is a wire data network, regardless of voice and data. The packets inputted to the local area network (LAN) are transmitted to the Internet or voice over Internet protocol (VoIP) gateway according to their destination. The voice packets transmitted to the voice over Internet protocol (VoIP) gateway are converted into pulse code modulation (PCM) voice data and transmitted to the private branch exchange (PBX) through an analog or digital interface, and the private branch exchange (PBX) transmits the inputted pulse code modulation (PCM) voice data to a local telephone or public switched telecommunications network (PSTN).

When the data packets are transmitted from the Internet to the wireless data communication terminals, the data packets are transmitted to the access point through the local area network (LAN). In the case that the voice packets are transmitted from the private branch exchange (PBX) to the wireless data communication terminals, the voice packets are also transmitted to the access point through the local area network (LAN).

As explained above, the voice packets and data packets are transmitted to the Internet, the private branch exchange (PBX) or the access point through the local area network (LAN) which is the wire data network. Accordingly, the voice packets and the data packets co-exist on the data network, and thus quality of voice is reduced in voice communication due to data traffic.

In addition, the access point is connected merely to the local area network (LAN), and thus installed with an alternating current/direct current (AC/DC) adaptor for power supply. However, it has many restrictions in installation due to alternating current (AC) power supply. A special local area network (LAN) switch would be required for a method of receiving power from a remote wire interface, and this would incur extra expense.

### SUMMARY OF THE INVENTION

The present invention provides a composite access point apparatus which can provide high quality voice services, and a method for processing voice packets and data packets using the composite access point apparatus.

The present invention also provides a composite access point apparatus which can easily receive power.

Additionally, the present invention provides a composite access point apparatus which has economical advantages.

The present invention provides a composite access point apparatus for a wireless data communication system using wireless local area network (WLAN), including: a wireless unit for wirelessly transmitting/receiving packets to/from random wireless data communication terminals; a voice data processor for decoding the inputted voice packets into pulse code modulation (PCM) voice data and outputting the resultant data, and coding the inputted pulse code modulation (PCM) voice data into voice packets, removing echo and outputting the resultant data; a voice interface for outputting the pulse code modulation (PCM) voice data from the voice data processor to a private branch exchange (PBX) or key telephone system, and outputting the pulse code modulation (PCM) voice data from the private branch exchange (PBX) or key telephone system to the voice data processor; a controller for examining a destination Internet protocol (IP) address of the packets from the wireless unit, outputting the packets to the voice data processor when the destination Internet protocol (IP) address is an Internet protocol (IP) address of the composite access point apparatus, and outputting the packets to a data interface when the destination Internet protocol (IP) address is not the Internet protocol (IP) address of the composite access point apparatus; and the data interface for outputting the data packets from the controller to a data network, and outputting the data packets from the data network to the controller.

There is also provided a method for processing voice packets and data packets by a composite access point apparatus for a wireless data communication system using wireless local area network (WLAN), including the steps of: preparing a voice data processor for decoding inputted voice packets into pulse code modulation (PCM) voice data and coding inputted pulse code modulation (PCM) voice data into voice packets; examining a destination Internet protocol (IP) address of packets when the packets are received from random wireless data communication terminals; and decoding the packets into pulse code modulation (PCM) voice data and outputting the resultant data to a private branch exchange (PBX) or key telephone system connected to the composite access point apparatus when the destination Internet protocol (IP) address is an Internet protocol (IP) address of the composite access point, and outputting the packets to a data network when the destination Internet protocol (IP) address is not the Internet protocol (IP) address of the composite access point.

In accordance with the principles of the present invention, as embodied and broadly described, the present invention provides a composite access point apparatus for a wireless data communication system, the apparatus comprising: a wireless unit wirelessly transmitting first packets to at least one wireless data communication terminal selected from among a plurality of wireless data communication terminals of a wireless local area network, said wireless unit wirelessly receiving second packets from at least one wireless data communication terminal selected from among the plurality of wireless data communication terminals of the wireless local area network, the first packets including at least one selected from among first voice packets and first data packets, the second packets including at least one selected from among second voice packets and second data packets; a voice data processor inputting the second voice packets received by said wireless unit, said voice data processor decoding the inputted second voice packets to form second pulse code modulation voice data and outputting the formed second pulse code modulation voice data, said voice data processor receiving first pulse code modulation voice data and coding the received first pulse code modulation voice data to form the first voice packets and outputting the formed first voice packets to said wireless unit; a voice interface outputting the formed second pulse code modulation voice data from said voice data processor to a voice communications system, said voice interface outputting the first pulse code modulation voice data received from the voice communications system to said voice data processor; a data interface receiving the first data packets from a data network and outputting the first data packets to said wireless unit; and a controller detecting a destination Internet protocol address of the second packets received by said wireless unit, said controller determining when the second packets received by said wireless unit correspond to the second voice packets in dependence upon the detected destination Internet protocol address of the second packets received by said wireless unit, said controller outputting the second packets received by said wireless unit to said voice data processor when the destination Internet protocol address of the second packets does correspond to an Internet protocol address of the composite access point apparatus, said controller outputting the second packets received from said wireless unit to said data interface when the destination Internet protocol address does not correspond to the Internet protocol address of the composite access point apparatus, said data interface outputting the second data packets received by said wireless unit to the data network.

In accordance with the principles of the present invention, as embodied and broadly described, the present invention provides an access point apparatus for a wireless data communication system, the apparatus comprising: a wireless unit wirelessly transmitting first packets to at least one wireless data communication terminal and wirelessly receiving second packets from the at least one wireless data communication terminal, the first packets including at least one selected from among first voice packets and first data packets, the second packets including at least one selected from among second voice packets and second data packets; a memory storing the first and second voice packets in a voice packet memory and storing the first and second data packets in a data packet memory, the voice packet memory outputting the first and second voice packets in accordance with a first-in first-out method, the data packet memory outputting the first and second data packets in accordance with the first-in first-out method, the voice packet memory being distinguishable from the data packet memory; a controller detecting a destination Internet protocol address of the second packets received from said wireless unit, said controller outputting the second packets to the voice packet memory when the destination Internet protocol address does correspond to an Internet protocol address of the composite access point apparatus, said controller outputting the second packets to the data packet memory when the destination Internet protocol address does not correspond to the Internet protocol address of the composite access point apparatus; a data interface outputting the second data packets from the data packet memory to a data network; a voice data processor for decoding the second voice packets from the voice packet memory into second pulse code modulation voice data and outputting the second pulse code modulation voice data; and a voice interface outputting the second pulse code modulation voice data from said voice data processor to at least one selected from among a private branch exchange and a key telephone system.

In accordance with the principles of the present invention, as embodied and broadly described, the present invention provides a method for processing voice packets and data packets by an access device for a wireless data communication system, the method comprising: receiving first packets at an access device; detecting a destination Internet protocol address of the first packets when the first packets are received from at least one wireless data communication terminal selected from among a plurality of wireless data communication terminals; and when the detected destination Internet protocol address of the first packets does correspond to an Internet protocol address of the access device, determining that the first packets correspond to first voice packets and decoding the first voice packets into first pulse code modulation voice data and outputting the first pulse code modulation voice data to a voice communications system connected to the access device; and when the detected destination Internet protocol address of the first packets does not correspond to the Internet protocol address of the access device, determining that the first packets correspond to first data packets and outputting the first data packets to a data network.

In accordance with the principles of the present invention, as embodied and broadly described, the present invention provides a method for processing voice packets and data packets by an access device for a wireless data communication system, the method comprising: transmitting first packets from an access device and receiving second packets at the access device, the first packets including at least one selected from among first voice packets and first data packets, the second packets including at least one selected from among second voice packets and second data packets; detecting a destination Internet protocol address of the second packets when the second packets are received from at least one wireless data communication terminal of a wireless local area network; and when the detected destination Internet protocol address of the second packets does correspond to an Internet protocol address of the access device, determining that the second packets correspond to the second voice packets and decoding the second voice packets into second pulse code modulation voice data and outputting the second pulse code modulation voice data to a voice communications system connected to the access device; and when the detected destination Internet protocol address of the second packets does not correspond to the Internet protocol address of the access device, determining that the second packets correspond to the second data packets and outputting the second data packets to a data network.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a structure diagram illustrating an exemplary wireless data communication system using wireless local area network (WLAN);

FIG. 2 is a structure diagram illustrating a wireless data communication system using wireless local area network (WLAN), in accordance with the principles of the present invention;

FIG. 3 is a diagram illustrating a layer structure of a wireless data communication terminal and a layer structure of a composite access point, in accordance with the principles of the present invention;

FIG. 4 is a block diagram illustrating the composite access point apparatus, in accordance with the principles of the present invention; and

FIG. 5 is a flowchart showing a process for processing voice packets and data packets by the composite access point apparatus, in accordance with the principles of the present invention.

### DESCRIPTION OF EMBODIMENTS FOR CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Exemplars of recent efforts related to wireless communications are disclosed, for example, in U.S. Pat. No. 6,434,129 to Struhsaker et al., entitled METHOD AND SYSTEM FOR AN AIR INTERFACE FOR PRO VIDING VOICE, DA TA, AND MULTIMEDIA SERVICES IN A WIRELESS LOCAL LOOP SYSTEM, issued on Aug. 13, 2002, U.S. Pat. No. 6,404,772 to Beach et al., entitled VOICE AND DATA WIRELESS COMMUNICATIONS NETWORK AND METHOD, issued on Jun. 11, 2002, U.S. Pat. No. 6,330,244 to Swartzetal, entitled SYSTEM FOR DIGITAL RADIO COMMUNICATION BETWEEN A WIRELESS LAN AND A PBX, issued on Dec. 11, 2001, U.S. Pat. No. 6,308,267 to Gremmelmaier, entitled ARRANGEMENT AND METHOD FOR MOBILE COMMUNICATIONS HAVING AN IP LINK, issued on Oct. 23, 2001, and U.S. Pat. No. 6,073,018 to Sallberg, entitled SYSTEM AND METHOD FOR INTER WORKING OF WIRELESS. While these contemporary efforts contain merit, it is my observation that further improvements can also be contemplated.

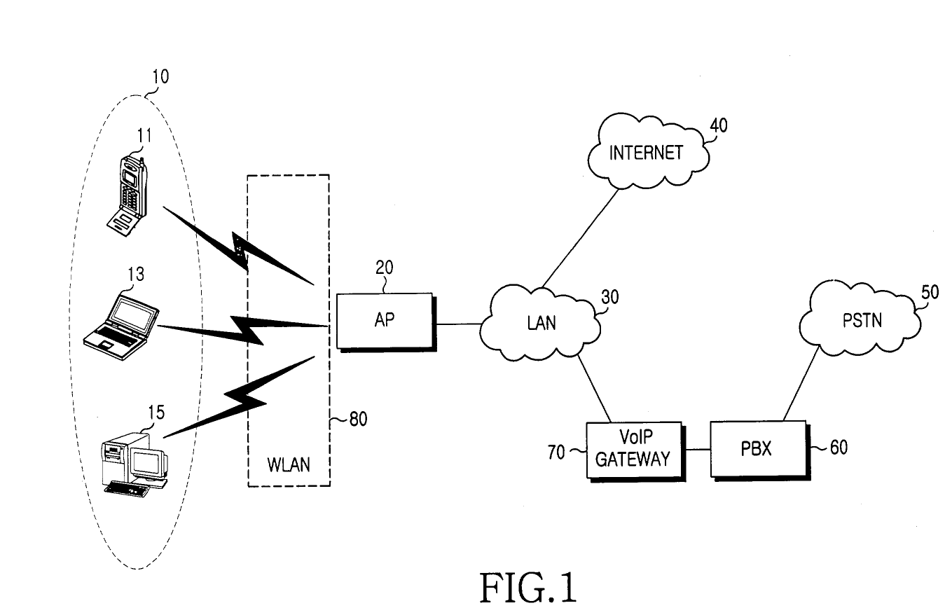

FIG. 1 is a structure diagram illustrating an exemplary wireless data communication system using wireless local area network (WLAN). Referring to FIG. 1, the wireless data communication system using wireless local area network (WLAN) includes wireless data communication terminals 10, an access point 20, a local area network (LAN) 30, Internet 40, a public switched telecommunications network (PSTN) 50, a private branch exchange (PBX) 60, a voice over Internet protocol (VoIP) gateway 70 and a wireless local area network (WLAN) 80.

A transmission path of voice packets and data packets in the wireless data communication system will now be explained. Here, the data packets imply data packets which need not to be transmitted in a real time like the voice packets. The wireless data communication terminals 10 such as a wireless voice over Internet protocol (VoIP) terminal 11, a personal digital assistant (PDA) 13 and a personal computer 15 on which a wireless local area network (WLAN) card is mounted transmit voice or data to the wireless local area network (WLAN) 80 in form of packets. The wireless data communication terminals 10 convert a voice signal inputted by a user into a pulse code modulation (PCM) voice data, and convert the pulse code modulation (PCM) voice data into a signal frame suitable for the wireless local area network (WLAN) communication standards by compression, thereby transmitting the voice data in form of packets like general data.

The access point 20 receiving the voice packets and data packets from the wireless data communication terminals 10 outputs the received packets to the local area network (LAN) 30 which is a wire data network, regardless of voice and data. The packets inputted to the local area network (LAN) 30 are transmitted to Internet 40 or voice over Internet protocol (VoIP) gateway 70 according to their destination. The voice packets transmitted to the voice over Internet protocol (VoIP) gateway 70 are converted into pulse code modulation (PCM) voice data and transmitted to the private branch exchange (PBX) 60 through an analog or digital interface, and the private branch exchange (PBX) 60 transmits the inputted pulse code modulation (PCM) voice data to a local telephone or public switched telecommunications network (PSTN) 50.

When the data packets are transmitted from Internet 40 to the wireless data communication terminals 10, the data packets are transmitted to the access point 20 through the local area network (LAN) 30. In the case that the voice packets are transmitted from the private branch exchange (PBX) 60 to the wireless data communication terminals 10, the voice packets are also transmitted to the access point 20 through the local area network (LAN) 30.

As explained above, the voice packets and data packets are transmitted to Internet 40, the private branch exchange (PBX) 60 or the access point 20 through the local area network (LAN) 30 which is the wire data network. Accordingly, the voice packets and the data packets co-exist on the data network, and thus quality of voice is reduced in voice communication due to data traffic.

In addition, the access point 20 is connected merely to the local area network (LAN) 30, and thus installed with an alternating current/direct current (AC/DC) adaptor for power supply. However, it has many restrictions in installation due to alternating current (AC) power supply. A method for receiving power from a remote wire interface can be contemplated. In this case, however, a special local area network (LAN) switch would be required and this would incur extra expense.

An embodiment of the present invention will be described herein below with reference to the accompanying drawings. It should be recognized that same drawing reference numerals are used for the same elements even in different drawings. In the following description, well-known functions or constructions are not described in detail since they would obscure the invention in unnecessary detail.

A composite access point apparatus 100 of the invention classifies voice packets and data packets inputted through a wireless local area network (WLAN), and transmits them to a local area network (LAN), private branch exchange (PBX), or key telephone system through a voice only path and a data only path.

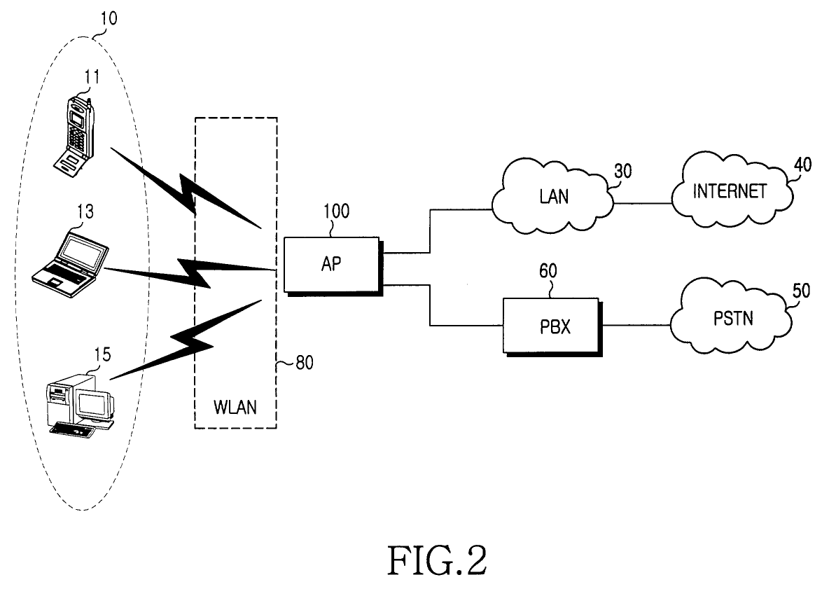

FIG. 2 is a structure diagram illustrating a wireless data communication system using wireless local area network (WLAN), in accordance with the principles of the present invention. A wireless data communication system including the composite access point apparatus is shown in FIG. 2.

Referring to FIG. 2, the wireless data communication system includes wireless data communication terminals 10, a local area network (LAN) 30, Internet 40, a public switched telecommunications network (PSTN) 50, a private branch exchange (PBX) 60, a wireless local area network (WLAN) 80 and a composite access point 100. The composite access point 100 is shown connected to private branch exchange (PBX) 60. The composite access point 100 can be connected to a key telephone system or to private branch exchange (PBX) 60 or both. Also, the composite access point 100 can be connected to a wire terminal for voice communications, or can be connected to other voice communications systems. The term “voice communications system” can correspond to a private branch exchange system, a key telephone system, and other devices for voice communications.

The wireless data communication terminals 10 including a wireless voice over Internet protocol (VoIP) terminal 11, a personal digital assistant (PDA) 13 and a personal computer 15 on which a wireless local area network (LAN) card is mounted transmit voice packets and data packets to the composite access point 100 through the wireless local area network (WLAN) 80. The wireless data communication terminals 10 are classified into a data only terminal for transmitting/receiving data packets, a voice only terminal for transmitting/receiving voice packets, and a composite communication terminal for transmitting/receiving both voice and data packets.

In accordance with the principles of the present invention, the composite access point 100 examines inputted packets and detects a destination Internet protocol (IP) address of those inputted packets, transmits the packets to the local area network (LAN) 30 when they are data packets, and converts the packets into pulse code modulation (PCM) voice data and transmits the resultant data to the private branch exchange (PBX) 60 when they are voice packets. Although the private branch exchange (PBX) 60 is exemplified as a device connected to the composite access point 100 for switching the voice data, a key telephone system can also be used. In addition, the data packets inputted from the local area network (LAN) 30 are transmitted to the wireless data communication terminals 10, and the pulse code modulation (PCM) voice data inputted from the private branch exchange (PBX) 60 are converted into voice packets and transmitted to the wireless data communication terminals 10. The local area network (LAN) 30 is a data network. The data packets transmitted to the local area network (LAN) 30 are transmitted to Internet 40, and the pulse code modulation (PCM) voice data transmitted to the private branch exchange (PBX) 60 are transmitted to a wire terminal or public switched telecommunications network (PSTN) 50 connected to the private branch exchange (PBX) 60. That is, the data packets received by the composite access point 100 are transmitted to Internet 40 through the local area network (LAN) 30, and the voice packets are converted into pulse code modulation (PCM) voice data and transmitted to the private branch exchange (PBX) without passing through the local area network (LAN) 30. The pulse code modulation (PCM) voice data transmitted from the private branch exchange (PBX) 60 are also transmitted to the composite access point 100 without passing through the local area network (LAN) 30. Accordingly, the data packets and the voice packets do not co-exist on the data network such as the local area network (LAN) 30, but have individual transmission paths. As a result, high quality voice services can be provided regardless of data traffic.

Still referring to FIG. 2, the composite access point 100 is connected not only to the local area network (LAN) 30 but also to the private branch exchange (PBX) 60, and thus receives power from the private branch exchange (PBX) 60.

The composite access point 100 classifies the data/voice packets from the wireless data communication terminals 10 by examining their destination Internet protocol (IP) addresses. The packets transmitted by the wireless data communication terminals 10 generally include destination Internet protocol (IP) addresses. When the packets are the data packets, they include a destination Internet protocol (IP) address positioned on a data network, and when the packets are the voice packets, they include an Internet protocol (IP) address of the access point to which the packets will be transmitted. Therefore, the composite access point 100 confirms the destination Internet protocol (IP) address of the packets inputted from the wireless data communication terminals 10, decodes the voice packets and transmits them to the wire network when the destination Internet protocol (IP) address of the packets is the Internet protocol (IP) address of the composite access point 100, and transmits the packets to the local area network (LAN) 30 when the destination Internet protocol (IP) address of the packets is not the Internet protocol (IP) address of the composite access point 100.

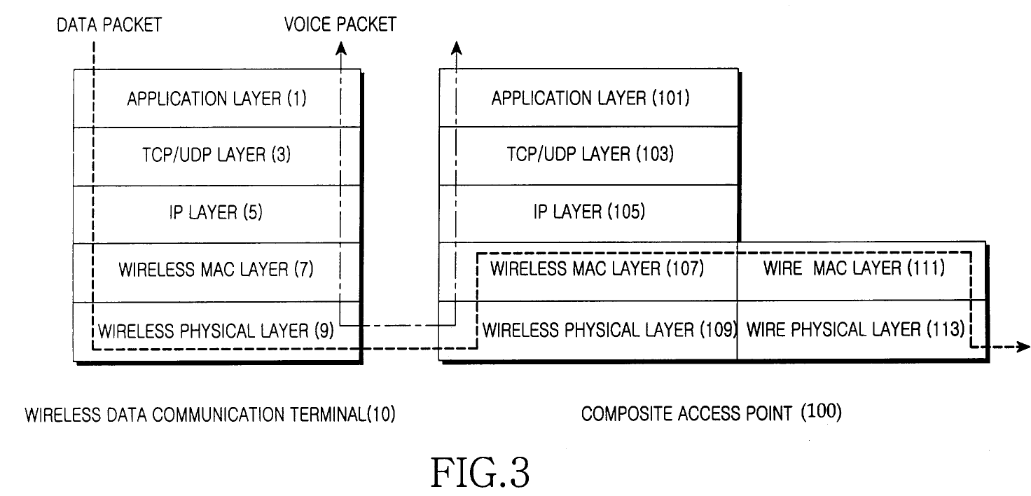

FIG. 3 is a diagram illustrating a layer structure of a wireless data communication terminal and a layer structure of a composite access point, in accordance with the principles of the present invention. FIG. 3 is a diagram illustrating a layer structure of the wireless data communication terminal 10 and a layer structure of the composite access point 100, especially paths of the layers which the packets are transmitted through in accordance with the principles of the present invention.

The wireless data communication terminal 10 includes an application layer 1, a transmission control protocol/user datagram protocol (TCP/UDP) layer 3, an Internet protocol (IP) layer 5, a wireless medium access control (MAC) layer 7 and a wireless physical layer 9, and the composite access point 100 includes an application layer 101, a transmission control protocol/user datagram protocol (TCP/UDP) layer 103, an Internet protocol (IP) layer 105, a wireless medium access control (MAC) layer 107, a wireless physical layer 109, a wire medium access control (MAC) layer 111 and a wire physical layer 113.

The wireless data communication terminal 10 forms the packets in a format suitable for wireless local area network (WLAN) transmission/reception through the application layer 1, the transmission control protocol/user datagram protocol (TCP/UDP) layer 3, the Internet protocol (IP) layer 5 and the wireless medium access control (MAC) layer 7, receives a destination Internet protocol (IP) address, and transmits the packets to the composite access point 100 through the wireless physical layer 9.

The composite access point 100 receives the packets through the wireless physical layer 109 and transmits them to the wireless medium access control (MAC) layer 107 which is a parent layer. The wireless medium access control (MAC) layer 107 examines the destination Internet protocol (IP) address and confirms whether the destination Internet protocol (IP) address is identical to the Internet protocol address of the composite access point 100. When the destination Internet protocol (IP) address is the Internet protocol (IP) address of the composite access point 100, the wireless medium access control (MAC) layer 107 recognizes the packets as voice packets and transmits them to the Internet protocol (IP) layer 105. The voice packets are processed properly, for example, decoded through the Internet protocol (IP) layer 105, the transmission control protocol/user datagram protocol (TCP/UDP) layer 103 and the application layer 101, and transmitted to a different wire network. When the destination Internet protocol (IP) address is not the Internet protocol (IP) address of the composite access point 100, the wireless medium access control (MAC) layer 107 recognizes the packets as data packets, bridges the data packets and transmits them to the wire medium access control (MAC) layer 111. The wire medium access control (MAC) layer 111 transmits the inputted data packets to the wire physical layer 113, and the wire physical layer 113 transmits them to the data network.

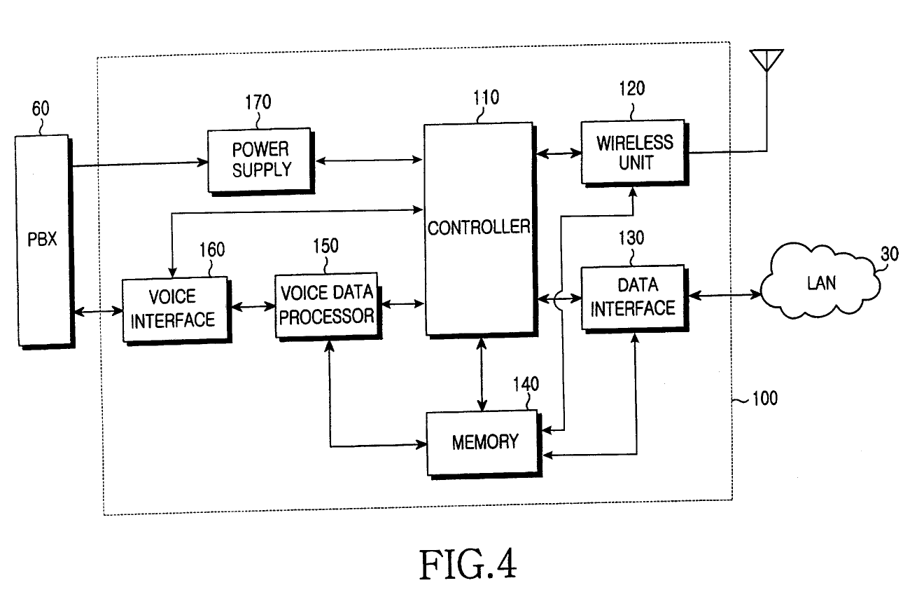

FIG. 4 is a block diagram illustrating the composite access point apparatus, in accordance with the principles of the present invention. As depicted in FIG. 4, the composite access point 100 includes a controller 110, a wireless unit 120, a data interface 130, a memory 140, a voice data processor 150, a voice interface 160 and a power supply 170.

The wireless unit 120 transmits packets to the wireless data communication terminals through the wireless local area network (WLAN) under the control of the controller 110. The wireless unit 120 receives packets from the wireless data communication terminals 10 through the wireless local area network (WLAN) under the control of the controller 110. The wireless unit 120 outputs the packets received from the wireless data communication terminals 10 to the controller 110, and outputs the packets received from the controller 110 to the wireless data communication terminals 10.

The wireless unit 120 can be said to wirelessly transmit first voice packets and first data packets to at least one wireless data communication terminal selected from among a plurality of wireless data communication terminals of the wireless local area network 80. The wireless unit 120 can be said to wirelessly receive second voice packets and second data packets from at least one wireless data communication terminal selected from among the plurality of wireless data communication terminals of the wireless local area network 80. In the foregoing two sentences, the terms “first” and “second” are merely labels that are used to help distinguish the received packets from the transmitted packets, and therefore, the terms “first” and “second” in the foregoing two sentences are not intended to indicate an order of occurrence in time.

The data interface 130 is a functional unit interfacing the data network and the composite access point 100. In accordance with the principles of the present invention, the data interface 130 transmits the inputted data packets to the local area network (LAN) 30 which is a data network, and outputs the data packets from the local area network (LAN) 30 to the controller 110.

The memory 140 includes a voice packet memory and a data packet memory. The voice packet memory and the data packet memory of the memory 140 output the inputted voice packets and data packets in the first-in first-out method under the control of the controller 110.

The voice data processor 150 decodes the inputted voice packets into pulse code modulation (PCM) voice data and outputs the resultant data to the voice interface 160. The voice data processor 150 can be said to decode the inputted voice packets to form pulse code modulation (PCM) voice data, and then output the formed pulse code modulation (PCM) voice data to the voice interface 160. In this case, the resultant data is the formed pulse code modulation (PCM) voice data.

The voice data processor 150 codes the inputted pulse code modulation (PCM) voice data into voice packets, removes echo and outputs the resultant data to the memory 140. The voice data processor 150 can be said to code the inputted pulse code modulation (PCM) voice data to form voice packets, remove echo, and then output the formed voice packets to the memory 140. In this case, the resultant data is the formed voice packets.

The voice interface 160 interfaces with a voice data switch connected to the composite access point 100 for voice data transmission/reception. The voice interface 160 transmits the pulse code modulation (PCM) voice data from the voice data processor 150 to the private branch exchange (PBX) 60. The voice interface 160 outputs the pulse code modulation (PCM) voice data from the private branch exchange (PBX) 60 to the voice data processor 150.

The power supply 170 receives power from the remote private branch exchange (PBX) and supplies power to all the functional terminals composing the composite access point 100 under the control of the controller 110.

The control unit 110 controls the whole operation of the composite access point 100, and also controls operations for processing the voice packets and data packets. When the controller 110 receives the packets from the wireless unit 120, the controller 110 examines the destination Internet protocol (IP) address of the packets. When the destination Internet protocol (IP) address is the Internet protocol (IP) address of the composite access point 100, the controller 110 outputs the packets to the voice packet memory of the memory 140, and controls the memory 140 to output the voice packets to the voice processor 150. When the destination Internet protocol (IP) address is not the Internet protocol (IP) address of the composite access point 100, the controller 110 outputs the packets to the data packet memory of the memory 140, and controls the memory 140 to output the data packets to the data interface 130.

In addition, the controller 110 outputs the data packets from the data interface 130 to the data packet memory, and controls the memory 140 to output the data packets to the wireless unit 120. Thereafter, the controller 110 controls the memory 140 so that the voice packets inputted from the voice data processor 150 to the voice packet memory can be outputted to the controller 110, and outputs the voice packets from the memory 140 to the wireless unit 120.

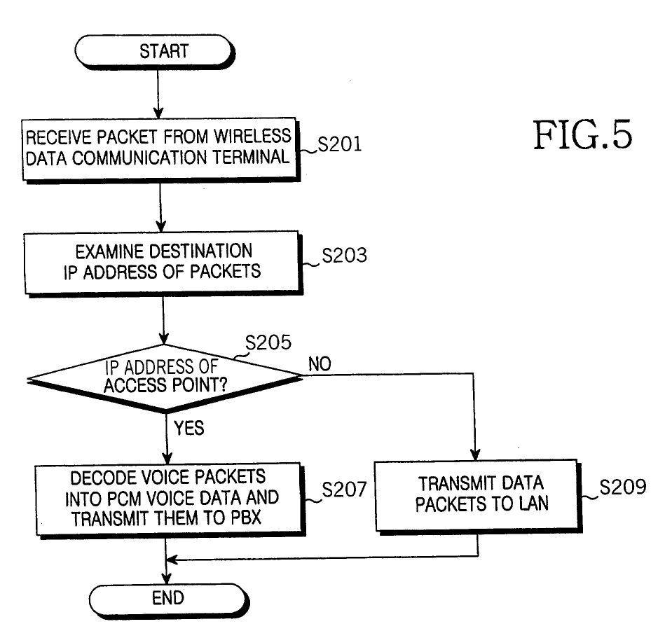

A process for the composite access point 100 to process the packets from the wireless data communication terminals 10 will now be explained with reference to FIG. 5. The FIG. 5 is a flowchart showing a process for processing voice packets and data packets by the composite access point apparatus, in accordance with the principles of the present invention.

As shown in FIG. 5, at step S201, the composite access point 100 receives the packets from the random wireless data communication terminal. At step S203, the composite access point 100 examines the destination Internet protocol (IP) address of the packets. At step S205, the composite access point 100 confirms whether the destination Internet protocol (IP) address is the Internet protocol (IP) address of the composite access point 100. The step S207 is performed after step S205 when the destination Internet protocol (IP) address is the Internet protocol (IP) address of the composite access point 100. The step S209 is performed after step S205 when the destination Internet protocol (IP) address is not the Internet protocol (IP) address of the composite access point 100.

At step S207, the composite access point 100 recognizes the packets as voice packets, decodes the voice packets into pulse code modulation (PCM) voice data, transmits them to the private branch exchange (PBX) 60, and ends the packet processing. At step S209, the composite access point 100 recognizes the packets as data packets, transmits them to the local area network (LAN) 30 which is the data network, and ends the packet processing.

The composite access point 100 can also be referred to as an access device 100. The power supply 170 receives power from the voice communications system and can supply power to all components of the composite access point 100. For example, the power supply 170 can supply power to the wireless unit 120 and the voice data processor 150 and the controller 110 and other components.

In accordance with the principles of the present invention, the voice communications system, which can be the private branch exchange 60 or a key telephone system or other voice communication facilitation unit, can conveniently supply power to the composite access point 100. The unit 60 shown in FIG. 4 is labeled as PBX 60. However, the unit 60 can also be referred to as a voice communications system 60, in accordance with the principles of the present invention. And the voice communications system 60 shown in FIG. 4 can include one or more of the following: a private branch exchange, a key telephone system, and other systems for voice communication.

As described above, in accordance with the present invention, the composite access point 100 can transmit the data packets and the voice packets by dividing their transmission/reception paths. Accordingly, the wireless data communication system can provide high quality voice services, and the general wireless data communication terminals perform the same functions as the wire key telephone system. Moreover, the composite access point 100 does not require a special voice over Internet protocol (VoIP) gateway. Since the composite access point 100 is connected directly to the private branch exchange (PBX) 60, it can easily receive power from the private branch exchange (PBX) 60. It is thus not necessary to install special equipment for power supply.

The foregoing paragraphs describe the details of the present invention as the present invention relates generally to a wireless data communication system and, in particular, as the present invention relates to a composite access point apparatus which can process voice packets and data packets at the same time in a wireless data communication system using a wireless local area network (WLAN), and as the present invention relates to a method for processing voice packets and data packets using the composite access point apparatus.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An apparatus for a wireless data communication system, the apparatus comprising:
a wireless unit wirelessly transmitting first packets to at least one wireless data communication terminal selected from among a plurality of wireless data communication terminals of a wireless local area network, said wireless unit wirelessly receiving second packets from at least one wireless data communication terminal selected from among the plurality of wireless data communication terminals of the wireless local area network, the first packets including at least one selected from among first voice packets and first data packets, the second packets including at least one selected from among second voice packets and second data packets;
a voice data processor inputting the second voice packets received by said wireless unit, said voice data processor decoding the inputted second voice packets to form second pulse code modulation voice data and outputting the formed second pulse code modulation voice data, said voice data processor receiving first pulse code modulation voice data and coding the received first pulse code modulation voice data to form the first voice packets and outputting the formed first voice packets to said wireless unit;
a voice interface outputting the formed second pulse code modulation voice data from said voice data processor to a voice communications system, said voice interface outputting the first pulse code modulation voice data received from the voice communications system to said voice data processor;
a data interface receiving the first data packets from a data network and outputting the first data packets to said wireless unit; and
a controller detecting a destination Internet protocol address of the second packets received by said wireless unit, said controller determining when the second packets received by said wireless unit correspond to the second voice packets in dependence upon the detected destination Internet protocol address of the second packets received by said wireless unit, said controller outputting the second packets received by said wireless unit to said voice data processor when the destination Internet protocol address of the second packets does correspond to an Internet protocol address of the composite access point apparatus, said controller outputting the second packets received from said wireless unit to said data interface when the destination Internet protocol address does not correspond to the Internet protocol address of the composite access point apparatus, said data interface outputting the second data packets received by said wireless unit to the data network.

2. The apparatus of claim 1, further comprising a power supply receiving power from the voice communications system and supplying power at least to said wireless unit, said voice data processor, and said controller.

3. The apparatus of claim 1, said controller controlling the outputting of the first data packets from said data interface to said wireless unit and the outputting of the first voice packets from said voice data processor to said wireless unit.

4. The apparatus of claim 1, said voice data processor removing echo when said voice data processor codes the received first pulse code modulation voice data to form the first voice packets and outputs the formed first voice packets to said wireless unit.

5. The apparatus of claim 1, the voice communications system corresponding to at least one selected from among a private branch exchange system and a key telephone system.

6. The apparatus of claim 1, further comprising a memory storing the first packets before the first packets are transmitted from said wireless unit, said memory storing the second packets after said wireless unit receives the second packets.

7. The apparatus of claim 6, further comprising a power supply receiving power from the voice communications system, said wireless unit performing the transmitting and receiving in dependence upon the power received from the voice communications system, said voice data processor performing the coding and decoding in dependence upon the power received from the voice communications system, said controller performing the detecting and determining in dependence upon the power received from the voice communications system.

8. The apparatus of claim 7, said controller controlling the outputting of the first data packets from said data interface to said wireless unit and the outputting of the first voice packets from said voice data processor to said wireless unit.

9. The apparatus of claim 8, said voice data processor removing echo when said voice data processor codes the received first pulse code modulation voice data to form the first voice packets and outputs the formed first voice packets to said wireless unit.

10. The apparatus of claim 9, the voice communications system corresponding to at least one selected from among a private branch exchange system and a key telephone system.

11. The apparatus of claim 9, said power supply supplying power at least to said controller and said voice data processor.

12. An apparatus for a wireless data communication system, the apparatus comprising:
a wireless unit wirelessly transmitting first packets to at least one wireless data communication terminal and wirelessly receiving second packets from the at least one wireless data communication terminal, the first packets including at least one selected from among first voice packets and first data packets, the second packets including at least one selected from among second voice packets and second data packets;
a memory storing the first and second voice packets in a voice packet memory and storing the first and second data packets in a data packet memory, the voice packet memory outputting the first and second voice packets in accordance with a first-in first-out method, the data packet memory outputting the first and second data packets in accordance with the first-in first-out method, the voice packet memory being distinguishable from the data packet memory;
a controller detecting a destination Internet protocol address of the second packets received from said wireless unit, said controller outputting the second packets to the voice packet memory when the destination Internet protocol address does correspond to an Internet protocol address of the composite access point apparatus, said controller outputting the second packets to the data packet memory when the destination Internet protocol address does not correspond to the Internet protocol address of the composite access point apparatus;
a data interface outputting the second data packets from the data packet memory to a data network;
a voice data processor for decoding the second voice packets from the voice packet memory into second pulse code modulation voice data and outputting the second pulse code modulation voice data; and
a voice interface outputting the second pulse code modulation voice data from said voice data processor to at least one selected from among a private branch exchange and a key telephone system.

13. The apparatus of claim 12, further comprising a power supply receiving power from the voice communications system, said power supply supplying the power received from the voice communications system at least to said wireless unit.

14. The apparatus of claim 12, said voice data processor receiving first pulse code modulation voice data and coding the received first pulse code modulation voice data into the first voice packets and outputting the first voice packets to said wireless unit, said voice data processor removing echo when said voice data processor codes the received first pulse code modulation voice data into the first voice packets and outputs the first voice packets to said wireless unit.

15. The apparatus of claim 14, further comprising a power supply receiving power from the voice communications system and supplying power at least to said wireless unit and said voice data processor.

16. A method of processing voice packets and data packets for a wireless data communication system, the method comprising:
receiving first packets at an access device;
detecting a destination Internet protocol address of the first packets when the first packets are received from at least one wireless data communication terminal selected from among a plurality of wireless data communication terminals;
when the detected destination Internet protocol address of the first packets does correspond to an Internet protocol address of the access device, determining that the first packets correspond to first voice packets and decoding the first voice packets into first pulse code modulation voice data and outputting the first pulse code modulation voice data to a voice communications system connected to the access device; and
when the detected destination Internet protocol address of the first packets does not correspond to the Internet protocol address of the access device, determining that the first packets correspond to first data packets and outputting the first data packets to a data network.

17. The method of claim 16, said detecting, decoding, and outputting being performed in dependence upon power received from the voice communications system.

18. The method of claim 16, the voice communications system corresponding to at least one selected from among a private branch exchange system and a key telephone system.

19. The method of claim 16, further comprising:
receiving second data packets at the access device from a data network;
transmitting the second data packets from the data network to at least one wireless data communication terminal selected from among the plurality of wireless data communication terminals;
receiving second pulse code modulation voice data at the access device from the voice communications system; and
coding the second pulse code modulation voice data into second voice packets and transmitting the second voice packets to at least one wireless data communication terminal selected from among the plurality of wireless data communication terminals.

20. The method of claim 19, further comprising removing echo when performing said coding of the second pulse code modulation voice data into the second voice packets and transmitting the second voice packets.

21. A method of transmitting and receiving voice packets and data packets for a wireless data communication system, the method comprising:
transmitting first packets from an access device and receiving second packets at the access device, the first packets including at least one selected from among first voice packets and first data packets, the second packets including at least one selected from among second voice packets and second data packets;
detecting a destination Internet protocol address of the second packets when the second packets are received from at least one wireless data communication terminal of a wireless local area network;
when the detected destination Internet protocol address of the second packets does correspond to an Internet protocol address of the access device, determining that the second packets correspond to the second voice packets and decoding the second voice packets into second pulse code modulation voice data and outputting the second pulse code modulation voice data to a voice communications system connected to the access device; and
when the detected destination Internet protocol address of the second packets does not correspond to the Internet protocol address of the access device, determining that the second packets correspond to the second data packets and outputting the second data packets to a data network.
